(19) United States
(12) Patent Application Publication
(10) Pub. No.: US 2020/0168129 A1
(43) Pub. Date: May 28, 2020

(54) Extended Content Label Tag

(71) Applicant: Resource Label Group, LLC, Franklin, TN (US)

(72) Inventors: Nick Testanero, Torrington, CT (US); Kevin P Frydryk, Naperville, IL (US)

(21) Appl. No.: 16/201,632

(22) Filed: Nov. 27, 2018

(51) Int. Cl. G09F 3/00; G06K 7/10; H04B 5/00

(52) U.S. Cl. CPC G09F 3/0288; G06K 7/10386; G09F 2003/0272; G09F 3/0297; H04B 5/0031

(57) ABSTRACT

A label, product, and system for an extended content label tag are disclosed. The label may include a body and an extended content portion. The extended content portion may be disposed on the body. The extended content portion may include one or more surfaces which may include printed content. The label may include a near-field communication (NFC) tag. The NFC tag may include one or more NFC circuits configured to wirelessly transmit data stored on the NFC tag. In some embodiments, the NFC tag may be operable to wirelessly transmit the data stored on the NFC tag to an NFC-enabled electronic device in response to receiving an activating signal from the NFC-enabled electronic device. In response to receiving the wirelessly transmitted data from the NFC tag, the NFC-enabled electronic device may be configured to display additional content. The additional content may include content additional to the printed content.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

Not Applicable

### STATEMENT REGARDING

### FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

Many products, devices, or packaging for products or devices include labels. These labels often convey important information on them, such as health and safety information. However, these labels have only a limited amount of space to convey this information, Extended content labels are capable of providing more space to convey information. However, extended context labels provide more space for information at the expense using more label material. Furthermore, an extended content label can only convey printed information that cannot be modified once printed and the product is placed in commerce.

What are needed, then, are improvements to extended content label technology.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The disclosure discusses a label with an extended content portion. The body of the label of the extended content portion may include content such as printed content. The label may include a near-field communication (NFC) tag coupled to a portion of the label. An NFC-enabled electronic device may receive data from the NFC tag and, in response, display additional content that is not present on the body of the label, the extended content portion of the label, or the container or product the label is attached to. The additional content may include content received from a remote data storage device. The additional content may include a webpage, document, video, or other types of content.

One aspect of the disclosure is a label. The label may include a body. The label may include an extended content portion. The extended content portion may be disposed on the body. The extended content portion may include one or more surfaces. A surface of the one or more surfaces may include printed content. The label may include an NFC tag. The NFC tag may include one or more NFC circuits configured to wirelessly transmit data stored on the NFC tag. In some embodiments, the NFC tag may be operable to wirelessly transmit the data stored on the NFC tag to an NFC-enabled electronic device in response to receiving an activating signal from the NFC-enabled electronic device. In response to receiving the wirelessly transmitted data from the NFC tag, the NFC-enabled electronic device may be configured to display additional content. The additional content may include content additional to the printed content.

Another aspect of the disclosure is a product. The product may include a container. The product may include a label coupled to the container. The label may include a body. The label may include an extended content portion. The extended content portion may be disposed on the body. The extended content portion may include one or more surfaces. A surface of the one or more surfaces may include printed content. The label may include an NFC tag. The NFC tag may include one or more NFC circuits configured to wirelessly transmit data stored on the NFC tag. In some embodiments, the NFC tag may be operable to wirelessly transmit the data stored on the NFC tag to an NFC-enabled electronic device in response to receiving an activating signal from the NFC-enabled electronic device. In response to receiving the wirelessly transmitted data from the NFC tag, the NFC-enabled electronic device may be configured to display additional content. The additional content may include content additional to the printed content.

Another aspect of the disclosure is a system. The system may include a label. The label may include printed content. The label may include an extended content portion. The label may include an NFC tag. The NFC tag may be coupled to the label. The NFC tag may include data linking to a remote data storage device. The system may include the remote data storage device. The remote data storage device may include additional content. The additional content may include content additional to the printed content of the label. The NFC tag may be capable of transmitting the data to an electronic device in response to the electronic device activating the NFC tag. The electronic device may be capable of receiving the transmitted data from the NFC tag via an NFC reader. The remote data storage device may be capable of transmitting the additional content to the electronic device via a data network in response to receiving a request from the electronic device. The request may be based on the first data transmitted from the NFC tag.

Numerous other objects, advantages and features of the present disclosure will be readily apparent to those of skill in the art upon a review of the following drawings and description of a preferred embodiment.

### BRIEF DESCRIPTION OF THE DRAWINGS

FIG. 1 is a perspective view of one embodiment of an extended content label with an NFC tag.

FIG. 2 is a perspective view of one embodiment of a product with an extended content label and NFC tag.

FIG. 3 is a schematic view of one embodiment of a system for an extended content label with an NFC tag.

FIG. 4A is a front view of one embodiment of a system for an extended content label with an NFC tag.

FIG. 4B is a front view of one embodiment of an electronic device with an interface activated by reading an NFC tag.

FIG. 5A is a front view of one embodiment of an extended content label.

FIG. 5B is a back view of one embodiment of an extended content label.

FIG. 6A is a front view of one embodiment of an extended content label.

FIG. 6B is a front view of one embodiment of an opened extended content label.

FIG. 7A is a front view of one embodiment of an extended content label.

FIG. 7B is a front view of one embodiment of an opened extended content label.

FIG. 7C is a front view of one embodiment of an opened extended content label.

### DETAILED DESCRIPTION

While the making and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” “in another embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. The term “or” means “and/or” unless expressly specified otherwise.

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the claims. Furthermore, there is no intention to be bound by any expressed or implied theory presented in the preceding technical field, background, summary, or the following detailed description.

In the drawings, not all reference numbers are included in each drawing, for the sake of clarity. In addition, positional terms such as “upper,” “lower,” “side,” “top,” “bottom,” etc. refer to an apparatus when in the orientation shown in the drawing. A person of skill in the art will recognize that an apparatus can assume different orientations when in use.

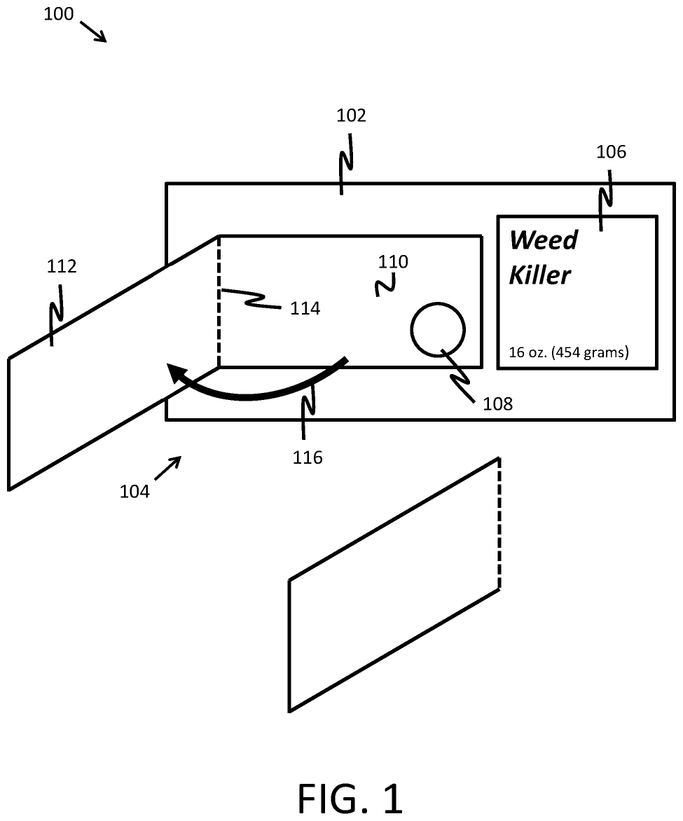

FIG. 1 depicts one embodiment of a label 100. The label 100 may include an extended content label. The label 100 may include a body 102. A portion of the body 102 may be coupled to a product. The label 100 may include an extended content portion 104. The extended content portion 104 may be disposed on the body 102. The extended content portion 104 may include one or more surfaces. The body 102 or a surface of the extended content portion 104 may include printed content 106. The printed content 106 may include text, images, or other printed information. The printed content 106 may include a product name, instructions, safety information, or other information about the product the label 100 is coupled to.

The label 100 may include a near-field communication (NFC) tag 108. The NFC tag 108 may include one or more NFC circuits. The NFC circuits may be configured to wirelessly transmit data stored on the NFC tag 108. The NFC tag 108 may include data. The NFC tag 108 may be pre-programmed with the data. The NFC tag 108 may be operable to wirelessly transmit the data stored on the NFC tag 108 to an NFC-enabled electronic device. The NFC tag 108 may transmit the data in response to receiving an activating signal from the NFC-enabled electronic device or some other activating device. In response to receiving the wirelessly transmitted data from the NFC tag 108, the NFC-enabled electronic device may be configured to display additional content. The additional content may include content additional to the printed content 106.

In some embodiments, the data stored on the NFC tag 108 may include a link to data on a remote data storage device. The data on the remote data storage device may include the additional content. The additional content may include text, images, graphics, videos, or other information not included on the label 100. The additional content may include information included on the label 100 but in a different format. A different format may include audio, video, one or more images, another language, or other formats. The NFC-enabled electronic device may use the link to access the additional content.

As can be seen from the above description, in some embodiments, by providing a label 100 with an accompanying NFC tag 108, a consumer of a product or service associated with the label 100 can quickly and conveniently access content or data beyond the content included on the label 100. Furthermore, in order for a business to add more content beyond what is found on the label 100 or to modify information conveyed by the label 100, the business does not need to print new labels, larger labels, or other conventional methods of adding information. Instead, the business may modify the data accessed by an NFC-enabled electronic device that reads the NFC tag 108.

In one embodiment, the label 100 may include a body 102. The body 102 may be coupled to a product or a product container. A portion of the body 102 (for example, the backside of the body 102) may couple to the container. The body 102 may couple to the container via an adhesive or another coupling mechanism. In some embodiments, the body 102 may include printed content 106. The printed content 106 may be printed on the body 102.

In another embodiment, the label 100 may include an extended content portion 104. The extended content portion 104 may include one or more surfaces that provide an area for printed content 106. The printed content 106 of the extended content portion 104 may be additional to the printed content 106 of the body 102. For example, as depicted in FIG. 1, the extended content portion 104 may include a booklet format. The booklet format may include a base portion 110 and a flap portion 112, The flap portion 112 may be connected to the base portion 110 via a hinge 114. In some embodiments, the base portion 110 and the flap portion 112 may include an integral piece of material and the hinge 114 may include a fold of that piece of material. A backside of the base portion 110 may be disposed on the body 102. In another embodiment, the base portion 110 may be integral with the body 102. As can be seen in FIG. 1, the flap portion 112 may swing away from the base portion 110 (as depicted by the arrow 116) to reveal portions of the base portion 110 or flap portion 112.

In some embodiments, the base portion 110 and the flap portion 112 may selectably couple together. The base portion 110 and the flap portion 112 may selectably couple together via an adhesive disposed on a portion of the base portion 110 or the flap portion 112. For example, an adhesive may be disposed along the edge of the flap portion 112 that is disposed opposite the hinge 114. The adhesive disposed on the flap portion 112 may selectably couple to an edge of the base portion 110 and hold the flap portion 112 to the base portion 110 until decoupled (e.g., by a user wanting to read the printed content 106 on the base portion 110 or the flap portion 112.

In one embodiment, one or more surfaces of the extended content portion 104 may include printed content 106. A front side of the base portion 110 may include printed content 106. A backside of the flap portion 112 (i.e., the side of the flap portion 112 facing toward the base portion 110 when the extended content portion 104 is closed) may include printed content 106. A front side of the flap portion 112 (i.e., the side of the flap portion 112 facing away from the base portion 110) may include printed content 106.

In some embodiments, the label 100 may include an NFC tag 108. The NFC tag 108 may include one or more NFC circuits. The one or more NFC circuits may include an antenna and a chip. The antenna may receive an activating signal from an activating NFC-enabled electronic device. The activating signal may include a magnetic field generated by the NFC-enabled electronic device. The received magnetic field may induce an electric current that powers the chip. The chip may generate a magnetic field in the antenna to wirelessly transmit data stored in the chip.

In one embodiment, the NFC tag 108 may be integrated into a portion of the label 100. For example, the NFC tag 108 may be printed onto a portion of the label 100. In another embodiment, the NFC tag 108 may be coupled to the body 102. In some embodiments, the NFC tag 108 may be coupled to the extended content portion 104. For example, as depicted in FIG. 1, the NFC tag 108 may be coupled to the base portion 110 of the extended content portion 104, The NFC tag 108 may be coupled to the flap portion 112. In some embodiments, the NFC tag 108 being coupled to a portion of the label 100 may include the NFC tag 108 including a sticker and the sticker being coupled to the portion of the label 100 via an adhesive. In one embodiment, the NFC tag 108 may be coupled to a backside of the body 102, a front side of the body 102, a backside of the base portion 110, a front side of the base portion 110, a backside of the flap portion 112, a front side of the flap portion 112, or another portion of the label 100. In some embodiments, coupling the NFC tag 108 on a portion of the label 100 closer to the body 102 may protect the NFC tag 108 from damage while the NFC tag 108 can still be wirelessly read by an NFC-enabled electronic device.

As discussed above, in response to receiving the wirelessly transmitted data from the NFC tag 108, an NFC-enabled electronic device may display additional content. The additional content may include content additional to the printed content 106. In some embodiments, the additional content may include content that is not included in the printed content 106. In some embodiments, the additional content may include information relating to the label 100 or a product the label 100 may be coupled to.

In one embodiment, the additional content may include updated information that does not appear in the printed content 106 of the label 100. The updated information may include a potential side effect, method of mitigating a safety issue, or other updated information. Such updated information may not have been available or known at the time the printed content 106 was printed. In one example, the label 100 may include a label for a chemical. The printed content 106 of the label 100 may indicate that a potential side effect of the chemical may include skin irritation. The printed content 106 may also include directions to follow if the chemical is spilled on skin. Later, it may be discovered that another potential side effect of the chemical may include lung irritation if inhaled. It may also be discovered that the directions in the printed content 106 are ineffective or harmful. The additional content may include a document with updated information indicating the potential side effect of inhaling the chemical. The additional content may include updated, more effective directions to follow when the chemical is spilled on a person's skin.

In some embodiments, the additional content may include safety information. For example, the additional content may include a document including a safety data sheet (SDS), material safety data sheet (MSDS), product safety data sheet (PSDS), or other data sheets. In one embodiment, the NFC-enabled electronic device may quickly retrieve the additional content that includes an MSDS. This may enable a user of the NFC-enabled electronic device to access the information on the MSDS and respond to a dangerous situation faster than if the user were to travel to the location where a printed MSDS copy is stored.

In another embodiment, the printed content 106 may include directions for using a product, and the additional content may include a video of a person following those directions and explaining the steps of the directions. Additional content in a video or audio format may be useful to a product user that cannot read or whose limited eyesight does not allow them to read the printed content 106.

In some embodiments, the additional content may include information that complies with legal regulations. In some embodiments, legal regulations may require a certain product to contain specified information on the product's label 100. The content required by these regulations may include a large amount of text or other information. Furthermore, these legal regulations may change over time. Transmitting the additional content that complies with the legal regulations to the NFC-enabled electronic device may allow businesses to continue to sell products without having to reprint the label 100 or remove products with non-compliant labels 100 from commerce. Transmitting the additional content may also allow businesses to save on label printing costs.

In some embodiments, the additional content may include a translation of the printed content 106 into another language. For example, the printed content 106 may be in English, and the additional content may include a translation of the printed content 106 in Spanish.

In one embodiment, the additional content may include marketing information, promotional information, or the like. For example, the additional content may include a coupon, discount code, or the like for the product the label 100 may be coupled to. The additional content may include an advertisement, such as a video commercial or a brochure, about the product.

In another embodiment, the additional content may include contact information for emergency services. The contact information may include a phone number. An electronic device capable of communication (e.g., a smartphone) may receive the contact information and may preload the information into a communication interface. For example, in response to receiving a phone number as the additional content, a smartphone may load the phone number into the native or default phone call application on the smartphone. In some embodiments, the smartphone may dial the number automatically. This may be useful in situations where a user of the electronic device may have limited sight or mobility due to, for example, an accident using the product such as spilling a chemical in the user's eyes.

In one embodiment, the additional content may include the printed content 106 but in an electronic format such that the NFC-enabled electronic device may display the additional content. This may be useful, for example, if a portion of the label 100 is rubbed off, obscured, or otherwise damaged such that at least a portion of the printed content 106 is rendered unreadable.

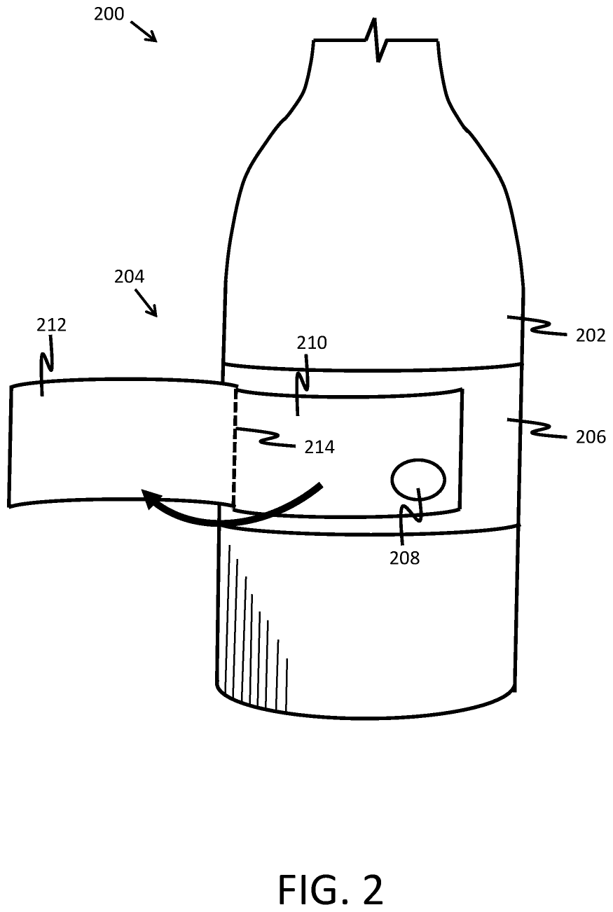

FIG. 2 depicts one embodiment a product 200, In one embodiment, the product 200 may include a container 202. The product 200 may include a label 204. The label 204 may be coupled to the container 202. The label 204 may include a body 206. The body 206 may be coupled to the container 202. The label 204 may include an extended content portion 210. The extended content portion may be disposed on the body 206. The label 204 may include an NFC tag 208.

In some embodiments, the container 202 may include a bottle, a box, a bag, or some other type of container. The container 202 may hold some kind of product such a chemical, a food or drink item, a consumer product, or some other kind of product. In some embodiments, the container 202 may include the product itself. For example, the product 200 may include a bicycle pump and the container 202 may include the bicycle pump itself. The label 204 may be coupled to the bicycle pump.

The product 200 may include a label 204. The label 204 may be similar to the label 100 discussed above. The product 200 may include an NFC tag 208, which may also be similar to the NFC tag 108 discussed above.

In some embodiments, the NFC tag 208 may be disposed between the body 206 of the label 204 and the container 202. For example, the NFC tag 208 may be coupled to an outside surface of the container 202 and the label 204 may be disposed over the NFC tag 208 and coupled to the container 202. In other examples, the NFC tag 208 may be coupled to a backside of the body 206 of the label 204, and the backside of the body 206 may be coupled to the outside surface of the container 202. The NFC tag 208 being disposed between the container 202 and the body 206 of the label 204 may protect the NFC tag 208 from being damaged by an external object while still being wirelessly readable by an NFC reader. In some embodiments, the NFC tag 208 may be integrated into the label 204 or the container 202. In another embodiment, the NFC tag 208 may be integrated into or coupled to another portion of the label 204, for example, as discussed above in relation to the label 100,

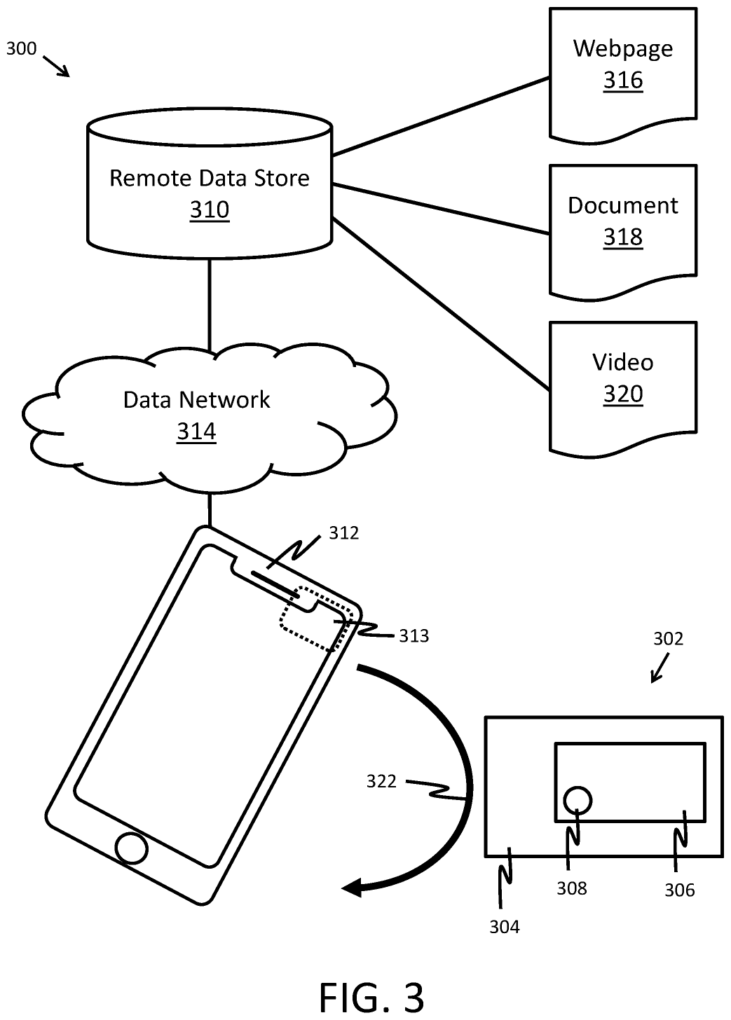

FIG. 3 depicts one embodiment of a system 300. The system 300 may include a label 302. The label 302 may include a body 304. The label 302 may include an extended content portion 306. The label 302 may include an NFC tag 308. The NFC tag 308 may be coupled to the label 302. In one embodiment, the NFC tag 308 may include data linking to a remote data storage device 310. The system 300 may include the remote data storage device 310. The remote data storage device 310 may include a database, a server, or another type of data storage device. The remote data storage device 310 may include additional content. The additional content may include content additional to printed content of the label 302.

In some embodiments, the NFC tag 308 may be capable of transmitting the data stored on the NFC tag 308 to an electronic device 312. The data may include data linking to the remote data storage device 310. The NFC tag 308 may transmit the data in response to the electronic device 312 activating the NFC tag 308. The electronic device 312 may be capable of receiving the transmitted data from the NFC tag 308. The electronic device 312 may receive the data via an NFC reader 313. The NFC reader 313 may be included in the electronic device 312. The remote data storage device 310 may be capable of transmitting the additional content to the electronic device 312. The remote data storage device 310 may transmit the additional content via a data network 314. The remote data storage device 310 may transmit the additional content in response to receiving a request from the electronic device 312. The request may be based on the data transmitted from the NFC tag 308.

In some embodiments, the remote data storage device 310 may include a device capable of storing data. The remote data storage device 310 may include a database, a server, or another type of data storage device. The remote data storage device 310 may receive data from and transmit data over the data network 314. The data network 314 may include a local area network (LAN), wide area network (WAN), the Internet, or another type of data network. The remote data storage device 310 may store a variety of data. The additional content may include a portion of the data.

In some embodiments, the additional content stored on the remote data storage device 310 may include updated content of the printed content of the label 302. For example, as mentioned above, the updated content may include information that does not appear in the printed content of the label 302, such as a potential side effect, method of mitigating a safety issue, or other updated information. The updated content may include a more current version of the printed content of the label 302.

In one embodiment, the additional content stored on the remote data storage device 310 may include a webpage 316. The additional content may include a document 318. The document 318 may include a text file, a portable document format (PDF) file, or another type of document. The additional content may include a video 320. The video 320 may include a video file, a video embedded in a webpage, or another type of video. The additional content stored on the remote data storage device 310 may include an audio file, an image file, a link to download a software application (app), or other types of data.

In some embodiments, the additional content stored on the remote data storage device 310 may be updated. Updating the additional content may include modifying or replacing a webpage 316, document 318, video 320, or other data stored on the remote data storage device 310. For example, as mentioned above, printed content of the label 302 may include information about potential side effects of the product associated with the label 302 or safety directions. A new potential side effect associated with the product may be discovered, or the safety directions may be found to be ineffective. In response, replacing or modifying a webpage 316, document 318, video 320, or other data associated with the product or label 302 on the remote data storage device 310 to include updated additional content may allow the electronic device 312 to access the updated additional content. In some embodiments, the remote data storage device 310 may include updated additional content in a webpage 316, document 318, video 320 or other data without modifying or replacing such stored data (e.g., a new webpage 316, document 318, video 320 or other data may include the updated additional content).

In one embodiment, the data included in the NFC tag 308 may include a link to the remote data storage device 310. The data may include a uniform resource locator (URL), uniform resource identifier (URI), a unique identifier (UID) (including a universally unique identifier (UUID)), an Internet Protocol (IP) address, or other data that can identify or locate a data resource on a network (such as the data network 314). The data included in the NFC tag 308 may identify or locate the additional content stored on the remote data storage device 310 such that the electronic device 312 can access the additional content.

In one embodiment, the electronic device 312 may include an NFC-enabled electronic device. The electronic device 312 may include a smartphone, a tablet computer, a mobile gaming device, a laptop computer, a desktop computer, a specialty NFC reading device, or another type of electronic device. The electronic device 312 may include an NFC reader 313. In some embodiments, the NFC reader 313 may be built into the electronic device 312. In other embodiments, the NFC reader 313 may include a peripheral device in data communication with the electronic device 312.

The electronic device 312 may receive the data from the NFC tag 308. In one embodiment, as depicted by the arrow 322 in FIG. 3, the electronic device 312 may move near the NFC tag 308, activate the NFC tag 308 and, in response, the NFC tag 308 may wirelessly transmit the data to the electronic device 312. The electronic device 312 may respond to the received data in a variety of ways. For example, in response to the data including a URL or URI, the electronic device 312 may send a request to the remote data storage device 310 requesting the information residing at the URL or URI. The request may include other data such as a UID or other data and place that request in the URL, URI, or a body portion of the request (such as a POST request method of a hypertext transfer protocol (HTTP) request). The request from the electronic device 312 may be sent over the data network 314 to the remote data storage device 310.

The remote data storage device 310 may respond to the received request. In response to receiving the request, the remote data storage device 310 may retrieve the additional content based on the request and send the additional content to the electronic device 312 over the data network 314. The electronic device 312 may receive the additional content and may display the additional content. For example, in response to receiving the webpage 316, the electronic device 312 may display the webpage 316 in a browser. In response to receiving the document 318, the electronic device 312 may display the document 318 using software capable of displaying the type of document 318. In response to receiving the video 320, the electronic device 312 may play the video 320.

In some embodiments, the data from the NFC tag 308 may include a file location on the electronic device 312. The additional content may be stored on the electronic device 312. In response to the electronic device 312 receiving the data, the electronic device 312 may use the data to locate the additional content on the electronic device 312 and use or display the additional content.

In another embodiment, the data on the NFC tag 308 may include the emergency contact information. In some embodiments, the amount of data capable of being stored on the NFC tag 308 may be limited, but emergency contact data, such as a phone number, may be small enough to be capable of being stored on the NFC tag 308. The NFC tag 308 may transmit the emergency contact data as the data from the NFC tag 308, and the receiving electronic device 312 may preload the emergency contact data as discussed above. In some embodiments, the electronic device 312 may not send a request to the remote data storage device 310 in response to receiving the additional content from the NFC tag 308 or locating the additional content on the electronic device 312.

In some embodiments, the additional content that the electronic device 312 may receive from the remote data storage device 310 may be tailored based on the request from the electronic device 312. For example, the request from the electronic device 312 may include location information. The location information may be included in the request or may be added to the request by another party, for example, an Internet service provider (ISP) or other similar party. The remote data storage device 310 may respond to the request based on the location information. As an example, the request from the electronic device 312 may include a request for instructions to use a certain product. The request may include an indication that the electronic device 312 is located in Japan. In response, the remote data storage device 310 may retrieve a document 318 with instructions in Japanese. The additional content tailored based on the request from the electronic device 312 may include promotions or marketing relating to a certain location, a certain type of user, or other information that may be included in the request.

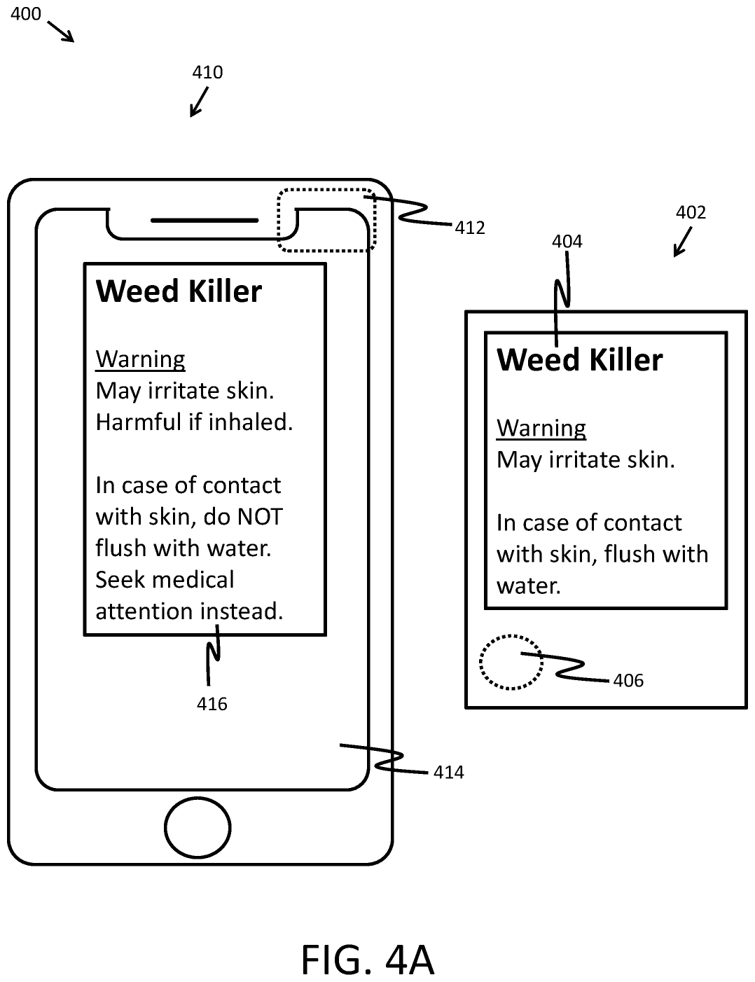

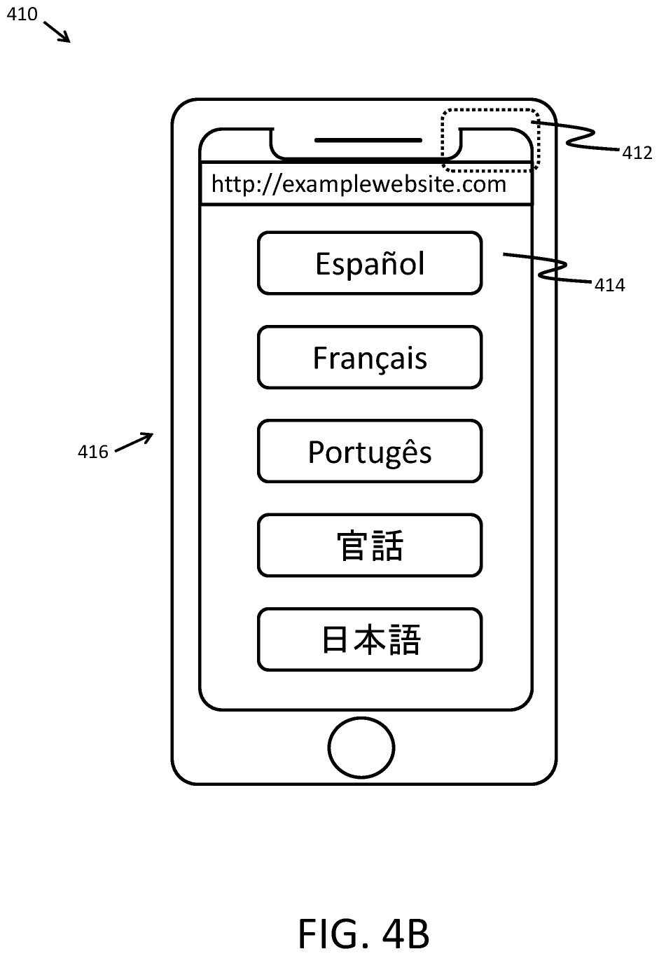

FIG. 4A depicts one embodiment of a system 400. The system 400 may include a label 402. The label 402 may include printed content 404 and an NFC tag 406. The label 402, printed content 404, and NFC tag 406 may similar to labels, printed content, and NFC tags discussed herein. The system 400 may include an electronic device 410. The electronic device 410 may be similar to the electronic device 312 discussed above. The electronic device 410 may include an NFC reader 412. The NFC reader 412 may receive data from an NFC tag through a wireless transmission. The electronic device 410 may include a display 414. The display 414 may include a screen capable of displaying content. The display 414 may display additional content 416 in response to receiving the data from the NFC tag 406.

As shown in FIG. 4A, the additional content 416 displayed on the display 414 of the electronic device 410 may include updated content. The updated content includes updated information about the information of the printed content 404 of the label 402. The additional content 416 includes an additional warning that the printed content 404 does not, i.e., “Harmful if inhaled.” The additional content 416 also includes replacement directions to the directions of the printed content 404, i.e., “In case of contact with skin, do NOT flush with water. Seek medical attention instead.”

FIG. 4B depicts one embodiment of the electronic device 410. As shown in FIG. 4B, the additional content 416 may include a webpage. The webpage may include the printed content of a label (e.g., the printed content 404 of the label 402) translated into different languages. In response to a user selecting a language (for example, by pressing a button displayed on the display 414), the display 414 may display the translated content.

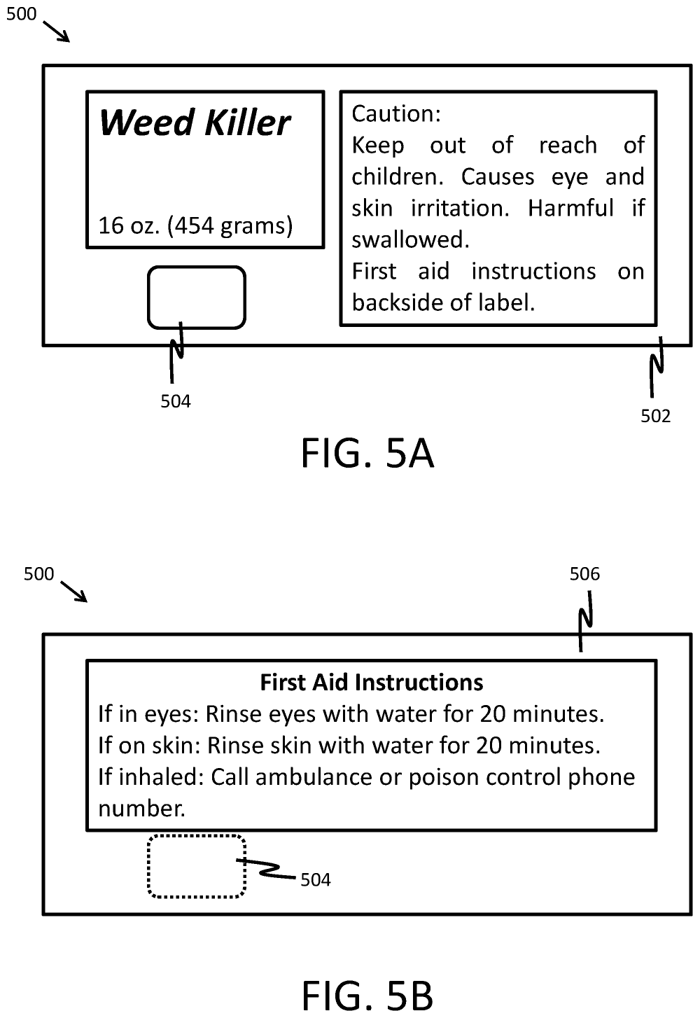

FIG. 5A and FIG. 5B depict one embodiment of a label 500. The label 500 may include a body 502. The body 502 may include printed content. The label 500 may include an NFC tag 504. The label 500 may include an extended content portion 506. As depicted in FIG. 5B, the extended content portion 506 may include a backside of the body 502, The extended content portion 506 may include an adhesive that may couple the extended content portion 506 to a container, product, or the like. When the container is transparent, a user may be able to read the content on the extended content portion 506 of the label 500 even though the content is not on the body 502 of the label 500.

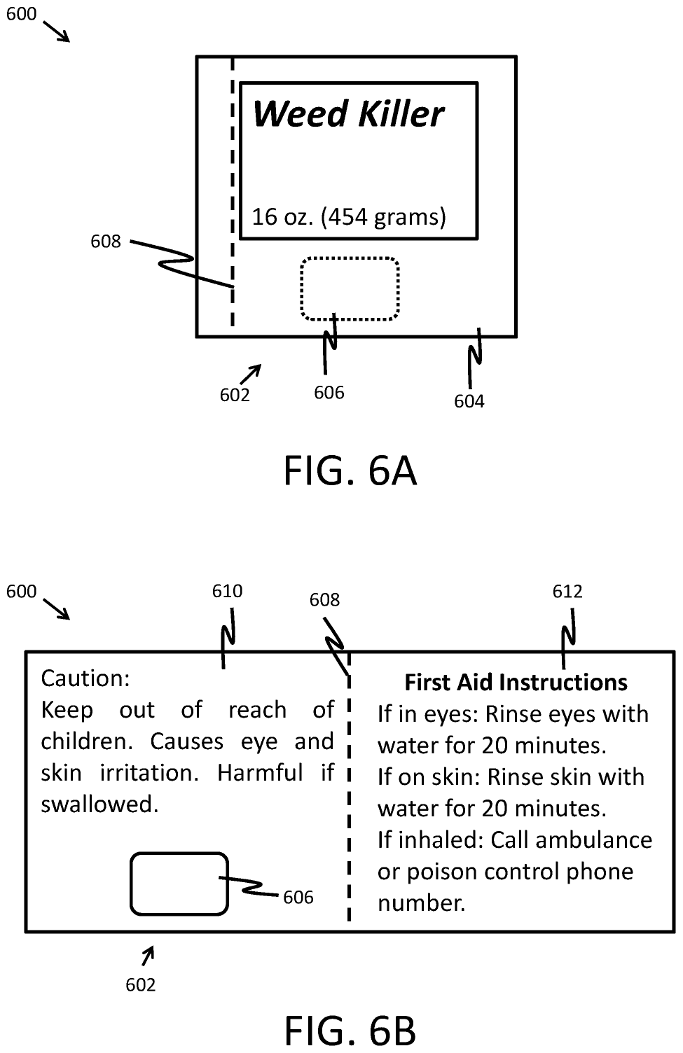

FIG. 6A and FIG. 6B depict one embodiment of a label 600. The label 600 may include a hinged, peel-away extended content label. The label 600 may include an extended content portion 602. The extended content portion 602 may include a first side 604. The label 600 may include an NFC tag 606, The label 600 may include a hinge 608. As depicted in FIG. 6B, when a user opens the label 600 by moving the edge of the extended content portion 602 that is disposed opposite the hinge 608, a second side 610 of the extended content portion 602 may be revealed to the user. The body 612 of the label 600 may also be revealed to the user. The extended content portion 602 may include a hinged, peel-away portion, One of the second side 610 of the extended content portion 602 or the body 612 may include an adhesive. The adhesive may selectably couple the second side 610 to the body 612.

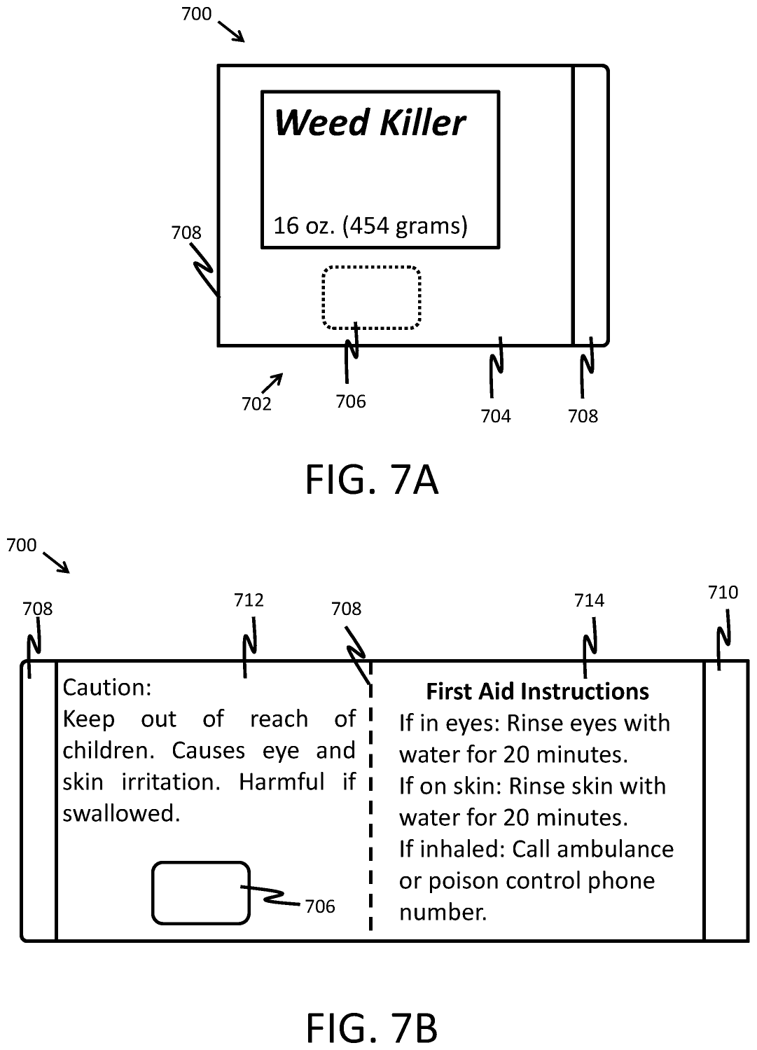

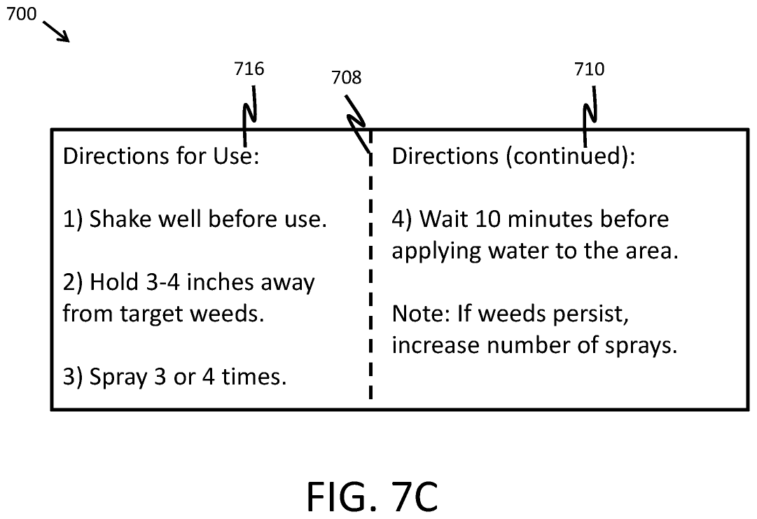

FIG. 7A, FIG. 7B, and FIG. 7C depict one embodiment of a label 700. The label 700 may include a booklet label. The label 700 may include an extended content portion 702. The extended content portion 702 may include a plurality of pages. As shown in FIG. 7A, the extended content portion 702 may include a first side 704 of a first page. The label 700 may include an NFC tag 706 and a hinge 708, which may be similar to those discussed above. In some embodiments, the extended content portion 702 may include an adhesive edge 708. The adhesive edge 708 may be disposed on the edge of the first page opposite the hinge 706. The adhesive edge 708 may include an adhesive on a side. The side with the adhesive may include the side facing away from the front of the extended content portion 702. The adhesive edge 708 may selectably couple the first page to the body 710 of the label. The adhesive edge 708, in some embodiments, may selectably couple the first page to a container the label is attached to.

As shown in FIG. 7B, the extended content portion 702 may include a plurality of pages. Each page may include a first side and a second side. For example, the first page of the extended content portion 702 of the label 700 may include a first side 704 and a second side 712. A second page may include a first side 714 and a second side 716 (shown in FIG. 7C). When the adhesive edge 708 couples to the body 710 or the container, the pages of the extended content portion 702 may press together to hold the extended content portion 702 shut.

In other embodiments not depicted in FIGS. 5-7, an extended content portion of a label may include other formats, styles, or the like. In some embodiments, a page of the extended content portion may fold along a second hinge. In other embodiments, the body of the label may include a hinge on multiple sides and each side may open up to reveal content. Such embodiments may include a tri-fold or a gate-fold label. In another embodiment, the label may include an accordion fold-style label where alternating edges of the extended content portion pages include a hinge. Other formats or styles of labels with extended content portions may also be used. An NFC tag may be disposed on a portion of the extended content portion or the body of a label.

In one embodiment, a label may not include an extended content portion. Such a label may nevertheless include an NFC tag. The tag may be disposed on the front side of the label, the back side of the label (i.e., between the label and the container), on the container, integrated into the label, or another area of the label or container.

Thus, although there have been described particular embodiments of the present invention of a new and useful EXTENDED CONTENT LABEL TAG, it is not intended that such references be construed as limitations upon the scope of this invention.

What is claimed is:

1. A label, comprising:
a body;
an extended content portion disposed on the body, the extended content portion including one or more surfaces, wherein a surface of the one or more surfaces includes printed content; and
a near-field communication (NFC) tag including one or more NFC circuits configured to wirelessly transmit data stored on the NFC tag;
wherein
the NFC tag is operable to wirelessly transmit the data stored on the NFC tag to an NFC-enabled electronic device in response to receiving an activating signal from the NFC-enabled electronic device, and
in response to receiving the wirelessly transmitted data from the NFC tag, the NFC-enabled electronic device is configured to display additional content including content additional to the printed content.

2. The label of claim 1, wherein the NFC tag is integrated into a portion of the label.

3. The label of claim 1, wherein the NFC tag is coupled to the body.

4. The label of claim 1, wherein the NFC tag is coupled to the extended content portion.

5. The label of claim 1, wherein the extended content portion comprises a booklet.

6. The label of claim 1, wherein the extended content portion comprises a hinged, peel-away portion.

7. The label of claim 1, wherein the extended content portion comprises a backside of the body.

8. The label of claim 1, wherein the data stored on the NFC tag comprises a pre-programmed link to data on a remote data storage device.

9. A product, comprising:
a container; and
a label coupled to the container, comprising:
a body;
an extended content portion disposed on the body, the extended content portion including one or more surfaces, wherein a surface of the one or more surfaces includes printed content; and
a near-field communication (NFC) tag including one or more NFC circuits configured to wirelessly transmit data stored on the NFC tag;
wherein
the NFC tag is operable to wirelessly transmit the data stored on the NFC tag to an NFC-enabled electronic device in response to receiving an activating signal from the NFC-enabled electronic device, and
in response to receiving the wirelessly transmitted data from the NFC tag, the NFC-enabled electronic device is configured to display additional content including content additional to the printed content.

10. The product of claim 9, wherein the NFC tag is disposed between the body of the label and the container.

11. The product of claim 9, wherein the NFC tag is integrated into the container.

12. The product of claim 9, wherein the data stored on the NFC tag comprises a pre-programmed link to data on a remote data storage device.

13. A system, comprising:
a label, comprising
printed content;
an extended content portion, and
a near-field communication (NFC) tag coupled to the label, the NFC tag including data linking to a remote data storage device; and
the remote data storage device including additional content, wherein the additional content includes content additional to the printed content of the label;
wherein
the NFC tag is capable of transmitting the data to an electronic device in response to the electronic device activating the NFC tag, the electronic device being capable of receiving the transmitted data from the NFC tag via an NFC reader, and
the remote data storage device is capable of transmitting the additional content to the electronic device via a data network in response to receiving a request from the electronic device, wherein the request is based on the data transmitted from the NFC tag.

14. The system of claim 13, wherein the additional content comprises updated content of the printed content of the label.

15. The system of claim 13, wherein the additional content comprises a webpage.

16. The system of claim 13, wherein the additional content comprises a document.

17. The system of claim 16, wherein the document comprises safety information.

18. The system of claim 13, wherein the additional content comprises a video.

19. The system of claim 13, wherein:
the printed content of the label comprises printed content in a first language; and
the additional content comprises the printed content translated into a second language.

20. The system of claim 13, wherein the additional content comprises emergency contact information that is capable of being preloaded into a communication interface of the electronic device.
